(19) United States
(12) Patent Application Publication
(10) Pub. No.: US 2008/0147730 A1
(43) Pub. Date: Jun. 19, 2008

(54) METHOD AND SYSTEM FOR PROVIDING LOCATION-SPECIFIC IMAGE INFORMATION

(75) Inventors: YONG C. LEE, CHANDLER, AZ (US); ROBIN I. LEE, CHANDLER, AZ (US); VON A. MOCK, BOYNTON BEACH, FL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/612,258

(22) Filed: Dec. 18, 2006

(51) Int. Cl. G06F 17/30; G06Q 30/00; G06F 15/16; H04N 5/235

(52) U.S. Cl. 707/104.1; 705/14; 709/217; 348/222.1; 707/E17.009; 348/E05.034

(57) ABSTRACT

A system (100) and method (200) for providing location-specific image information is provided. The method can include capturing (202) an image of an object from a mobile device (110), determining (204) a location of the mobile device, recognizing (206) the object from a database of images from the location, and retrieving (208) location-specific information associated with the object. A camera zoom (402), camera focus (412), and compass heading (422) can also be included for reducing a search scope. The method can include recognizing (306) a building in the image, identifying (320) a business associated with the building, retrieving an advertisement associated with the business, and overlaying the advertisement at a location of the building in the image. A list of contacts can also be retrieved (326) from an address of the recognized building and displayed on the mobile device.

### FIELD OF THE INVENTION

The present invention relates to mobile communication devices, and more particularly, to recognizing objects in a digitally captured image of a mobile device.

### BACKGROUND OF THE INVENTION

The use of portable electronic devices and mobile communication devices has increased dramatically in recent years. Moreover, mobile communication devices are offering more features to enhance the user experience. One feature is a mobile device camera which allows a user to take digital pictures. The user can send the picture to other users over a communications network for providing a shared user experience. The user can include a text to describe the picture or upload attachments to associate with the image. However, the picture may include objects with are unfamiliar to the user or other users. A need therefore exists for identifying objects within an image and providing descriptive information related to the objects.

### SUMMARY

One embodiment is a method for providing location-specific image information. The method can include receiving a captured an image of at least one object using a mobile device, recognizing the at least one object from both the image and a location of the mobile device, and retrieving location-specific information associated with the at least one object in the image in response to the recognizing. The method can further include identifying at least one business affiliated with the at least one object, retrieving an advertisement associated with the at least one business that can be overlaid onto the image. The method can further include identifying contact information associated with the at least one object from the location-specific information, and displaying the contact information on the mobile device. The step of recognizing can further include receiving the image and the location of the mobile device at an image server, recognizing the at least one object from the image and the location of the mobile device, and sending the location-specific information to the mobile device.

One embodiment is directed to a method for advertisement on a mobile device. The method can include receiving a captured image containing at least one object, determining a location of the mobile device, recognizing the at least one object from both the image and the location in a database of images, retrieving advertisements associated with the at least one object that can be overlaid onto the image. The method can further include recognizing a building in the image, identifying a business associated with the building, and retrieving an advertisement associated with the business. The method can further include identifying a coordinate of the business in the image, and overlaying the advertisement at the coordinate in the image. The method can further include receiving a camera zoom setting on the mobile device, generating a search radius for the at least one object in the image from the camera zoom setting, and performing the recognizing based on the search radius. The method can further include receiving a camera compass heading on the mobile device, generating a direction vector of the at least one object in the image from the camera compass heading, and performing the recognizing based on the viewing angle. The method can further include receiving a camera focus setting on the mobile device, generating a search arc for the viewing angle from the camera focus setting, and performing the recognizing based on the search arc. The method can further include adjusting the size of the overlay in proportion to an advertising revenue.

One embodiment is directed to a system for providing location-specific image information on a mobile device. The system can include an image server having a communication unit that receives the image and the location of the mobile device, an image database of objects to associate with the image at the location, and a recognition engine that recognizes the at least one object from the location and the image from the image database. The image server can retrieve location-specific information for the at least one object that is recognized and sends the location-specific information to the mobile device.

The system can further include an address server communicatively coupled to the image server that generates contact information for the location-specific information and that is associated with the at least one object. The system can further include an advertisement server communicatively coupled to the image server that retrieves advertisements associated with the location-specific information. The advertisement server can send the advertisements to the mobile device, and the mobile device can overlay the advertisements onto the image. The system can further include a mobility manager communicatively coupled to the address server that can monitor a location of users in a push-over-cellular (PoC) system and identify users that are at a location corresponding to the at least one object. In one aspect, the at least one object is a building, the image database contains a plurality of street-level images of buildings, and the image server recognizes a building from the image database and generates an address for the building. A list of contacts for the building can be generated and sent to the mobile device. In one arrangement, the mobility manager can sort the contact list in order of social activity level. A profile can also be included that determines the mobile device's displayed list of contacts based on a time or day.

One embodiment is an electronic apparatus for providing image specific information. The apparatus can include a camera that captures an image of at least one object, a locator coupled to the camera that identifies a location of the mobile device, a processor that recognizes the image; and a user interface that renders a composite of the original image and one or more sources of image specific information. Upon recognizing the image, the processor can identify image specific information associated with the image including contacts, advertisements, or messages that can be overlaid on the image in the user interface. The processor can also generate audio for the image specific information associated with the image.

### BRIEF DESCRIPTION OF THE DRAWINGS

The features of the system, which are believed to be novel, are set forth with particularity in the appended claims. The embodiments herein, can be understood by reference to the following description, taken in conjunction with the accompanying drawings, in the several figures of which like reference numerals identify like elements, and in which:

FIG. 1 is a wireless communication system for providing location-specific image information in accordance with the embodiments of the invention;

FIG. 2 is a method for providing location-specific image information in accordance with the embodiments of the invention;

FIG. 3 is a depiction for capturing an image in accordance with the embodiments of the invention;

FIG. 4 is a depiction for receiving location-specific image information in accordance with the embodiments of the invention;

FIG. 5 is a depiction for overlaying advertisements on a captured image in accordance with the embodiments of the invention;

FIG. 6 is an illustration for capturing at least a portion of a building in accordance with the embodiments of the invention;

FIG. 7 is an illustration for presenting a list of contacts in response to recognizing an image of a building in accordance with the embodiments of the invention;

FIG. 8 is a method for ad-hoc group call through listing and social network finder in accordance with the embodiments of the invention;

FIG. 9 is a method for searching images using a camera zoom setting in accordance with the embodiments of the invention;

FIG. 10 is a street-map identifying a search radius of an object in an image relative to a location of a mobile device in accordance with the embodiments of the invention;

FIG. 11 is a method for searching images using a camera compass heading in accordance with the embodiments of the invention;

FIG. 12 is a street-map identifying a compass heading of an object in an image relative to a location of a mobile device in accordance with the embodiments of the invention;

FIG. 13 is a method for searching images using a camera focus setting in accordance with the embodiments of the invention;

FIG. 14 is a street-map identifying a search arc of an object in an image relative to a location of a mobile device in accordance with the embodiments of the invention;

FIG. 15 is a method for generating a list of business contacts from a recognized building in accordance with the embodiments of the invention;

FIG. 16 is a method for generating a list of user contacts from a recognized building in accordance with the embodiments of the invention; and

FIG. 17 is a system for identifying users in a call group from an image based on a location of devices in accordance with the embodiments of the invention.

### DETAILED DESCRIPTION

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “image” can be defined as a picture or scene represented digitally. The term “location specific information” can be defined as information related one or more objects within an image. The term “recognizing” can be defined as identifying an object from visual aspects of an image. The term “building” can be defined as a physical structure.

Broadly stated, embodiments of the invention are directed to a method and system for capturing an image on a mobile device, identifying a location of the mobile device, and sending the image with the location of the mobile device to an image server that can recognize at least one object in the image. Camera settings can also be sent with the location for narrowing a search of the object in an image database. The image server can respond with location specific information associated with the at least one object given the location. The mobile device can present the location specific information with the image. As one example, the object can be a building in a street-level image scene and the location specific information can be an advertisement that is overlaid on the building. Advertisements or messages can be overlaid on multiple objects that are recognized in the image. As another example, the object can be a building and the location specific information can identify a list of personal or business contacts in the building. A user can take a picture of a building and receive a list of contacts associated with the building, or businesses within the building.

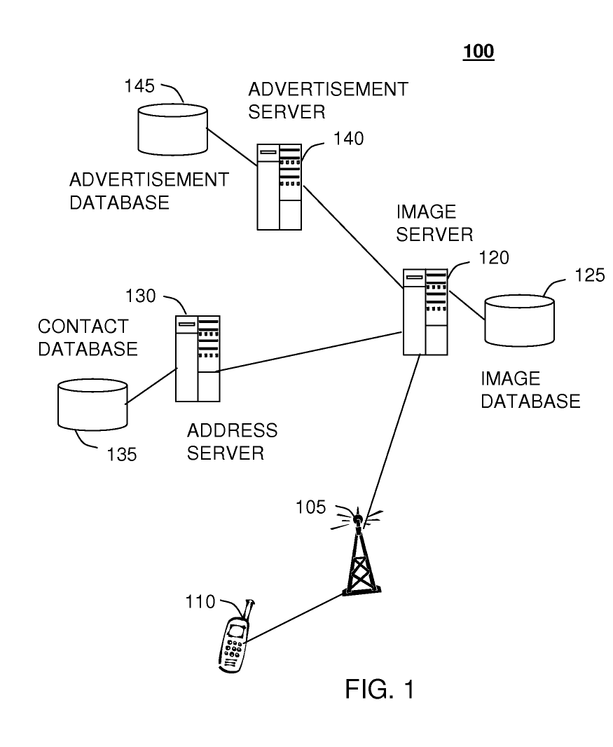

Referring to FIG. 1, a wireless communication system 100 for providing location-specific image information is shown. In one arrangement, the wireless system 100 can provide wireless connectivity or dispatch connectivity over a radio frequency (RF) communication network. The wireless communication system 100 can include a plurality of mobile devices communicating amongst one another in a group call or with other mobile devices or servers in the wireless communication system 100. In one arrangement, a mobile device 110 can communicate with one or more cellular towers 105 using a standard communication protocol such as CDMA, GSM, or iDEN, but is not herein limited to these. The one or more cellular towers 105, in turn, can connect the mobile device 110 through a cellular infrastructure to other mobile devices or resources on other networks.

Mobile devices in the wireless communication system 100 can also connect amongst one another over a Wide Local Area Network (WLAN) within an ad-hoc group. The WLAN provides wireless access within a local geographical area. The mobile devices can communicate with the WLAN according to the appropriate wireless communication standard. In another arrangement, the mobile devices can communicate amongst themselves in a peer-to-peer ad-hoc network without infrastructure or WLAN support. For example, the mobile device can use short-range radio communication to engage in a group call in a peer-to-peer mode. In a typical WLAN implementation, the physical layer can use a variety of technologies such as 802.11b or 802.11g Wireless Local Area Network (WLAN) technologies. The physical layer may use infrared, frequency hopping spread spectrum in the 2.4 GHz Band, or direct sequence spread spectrum in the 2.4 GHz Band, or any other suitable communication technology.

Briefly, the mobile device 110 can capture a picture, such as a street-level image, and send the picture to the image server 120. The image server 120 can recognize objects, such as buildings, within the picture. The image database 125 can include a plurality of images, such as street-level images, images of buildings, or images of businesses. Notably, the street-level images may include one or more buildings, and one or more businesses. The buildings and the businesses can each have an associated address. The image server 120 can identify the address of a building from the image using the image database 125 to provide a mapped location of the building. The image server 120 can send the address of the recognized buildings or businesses to the mobile device 110.

The image server 120 can also send the address to an address server 130, which can provide a list of contacts in the building or business. The address server 130 can include a contact database 135 that associates contact information with a given address. For example, upon receiving a building address from the image server 120, the address server 130 can generate a list of personal contacts associated with the building or business contacts in the building.

The image server 120 can also send the address to an advertisement server 140. The advertisement server 140 can include an advertisement database 145 having advertisements associated with business addresses or business contacts. The advertisement server 140, upon receiving address information or contact information from the image server 120, can send advertisements or location-specific information associated with the addresses or contacts to the image server 120. The image server 120 can send the advertisements and location-specific information to the mobile device 110.

The mobile device 110 can present the advertisements and/or location-specific information with the image. As one example, the mobile device 110 can overlay the advertisements at locations in the image corresponding to the location of the building or business recognized in the image. The user can visually see the advertisements overlaid on the image. As another example, the mobile device 110 can present a list of contacts associated with a business or building in the image. The list of contacts can include phone numbers, dispatch numbers, group identification numbers, web site names, or any other contact communication information. The user can call the contacts directly upon receiving the contact information.

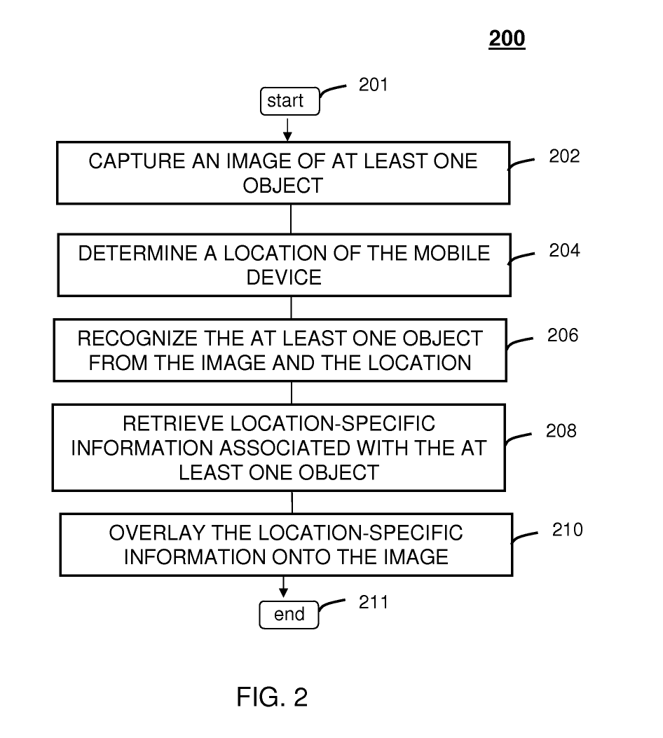

Referring to FIG. 2, a method 200 for providing location-specific image information is provided. The method 200 can be practiced with more or less than the number of steps shown. To describe the method 200, reference will be made to FIGS. 1 and 3-5, although it is understood that the method 200 can be implemented in any other manner using other suitable components. In addition, the method 200 can contain a greater or a fewer number of steps than those shown in FIG. 2.

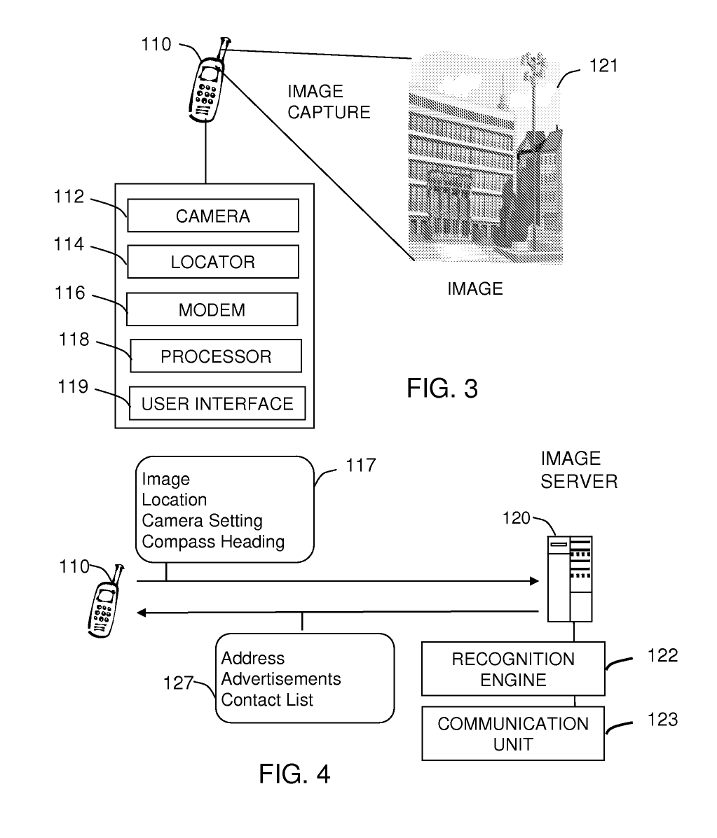

At step 201, the method can start. At step 202, an image of at least one object can be captured. For example, referring to FIG. 3, a user of the mobile device 110 can take a picture, such as a street-level image 121, of a scene. The image 121 may contain objects, portions of buildings, businesses, or other physical entities. In one arrangement, the image 121 can contain one or more buildings to be recognized.

The mobile device 110 can include a camera 112 that captures the image 121, a locator 114 coupled to the camera 112 that identifies a location of the mobile device 110, and a modem 116 coupled to the locator 114 that transmits the street-level image 121 and the location. The mobile device 110 can also include a processor 118 for coordinating a capturing of the image 121 and transmitting the image. The user can transmit the image 121 to the image server 120 to receive more location-specific information related to the building. The processor 118 can also produce an audio representation of the image-specific information. For example, the image specific information may be promotional audio and video advertisements associated with a business that is recognized in an image. The video advertisements can be overlaid on the image 121 in the user-interface 119 and an audio representation of the advertisements can be played through a speaker or headset of the mobile device 110. The user-interface 119 allows a user to receive visual feedback associated with the image specific information and to interact with the image specific information.

Returning back to FIG. 2, at step 204, a location of the mobile device can be determined. The location identifies a coordinate of the device in relation to the image. For example, referring to FIG. 3, the locator 114 can identify a physical coordinate of the mobile device 110, which may be a GPS location. The mobile device 110 can transmit the GPS location with the image to the image server 120. In one arrangement, a camera setting can also be sent with the location of the mobile device. The camera setting can identify a zoom setting of the image 121 to narrow a search for identifying the objects in the image. The camera 112 can also transmit a compass heading for identifying a direction of the image relative to the location of the mobile device 110.

Returning back to FIG. 2, at step 206, at least one object can be recognized from the image 121 from the identified location of the mobile device. The object may be a building or a business that can be recognized from a street-level image. For example, referring to FIG. 4, the mobile device 110 can send a packet of information 117 containing the street-level image 121, a location of the mobile device 110, a camera setting, and a compass heading to the image server 120. The image server 120 can include a communication unit 123 that receives the packet of information, and a recognition engine 122 that recognizes the building from the location information and the image from the image database 125.

Returning back to FIG. 2, at step 208, location specific information associated with the at least one object in the image can be retrieved in response to the recognizing. The location specific information can include an address, a list of contacts, or an advertisement that is associated with the at least one object but is not limited to these. For example, referring to FIG. 4, the image server, upon recognizing the objects in the image can send back a packet of information containing an address of a building or business recognized in the image, an advertisement associated with the building or business, or a contact list for people in the building or a contact list of users associated with a business in the building. In particular, referring back to FIG. 1, the image server 120 can generate an address for a building or business recognized in the street-level image. The address server 130 can process the address from the location-specific information, produce contact information associated with businesses and people in the building in view of the address, and send the contact information to the mobile device 110 through the image server 120. The image server 120 can also send the address and contact information to the advertisement server 140. The advertisement server 140 can retrieve advertisements associated with the address or contact information.

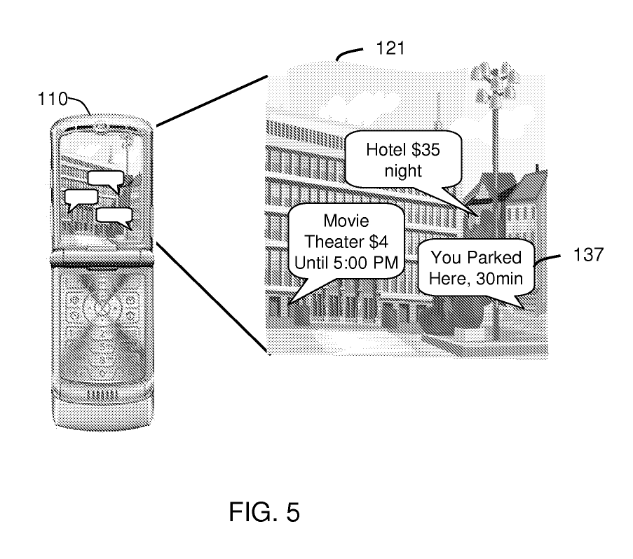

Returning back to FIG. 2, at step 210, the location specific information can be overlaid onto the image. For example, referring to FIG. 5, the mobile device 110 can overlay the advertisements 137 onto the captured image. Moreover, the advertisements 137 can be located at positions in the image corresponding to the building or business associated with the advertisement. For example, referring back to FIG. 1, the image server 120 can also send coordinates with the advertisements 137 to identify where the advertisements 137 should be placed in the image. In another arrangement, the image server 120 can directly overlay the advertisements 137 with the image, and send the updated image back to the mobile device 110. In such regard, the user can receive visually directed advertisements. That is, the advertisements are visually directed to the image 121 captured by the user at locations corresponding to the businesses or buildings offering the advertisements. In one arrangement, a service provider of the mobile device can adjust the size of the advertisement overlay in proportion to the advertising revenue paid. The advertisement overlay can be translucent or opaque so as to not entirely block the image.

The location specific information may also include notes or messages left by other individuals. For example, upon receiving the advertisements, a user may provide comments regarding the advertisement, such as favorable or negative reviews of the advertisement. Referring back to FIG. 1, the user can upload the comments to the mobility manager 115 which can then share the comments with other users in a call group. For example, if a second user takes a picture at the same location, with similar buildings or businesses identified, the second user can be provided with the feedback from the first user. As another example, a user may upload narrative information or user experience information to the mobility manager 115 related to recognized buildings or objects in the street-level image. A second user, passing by the same location, can receive the narrative information. For example, the mobility manager 115 can monitor a user's location based on GPS coordinates, and provide the narrative information or user experience information when a location of the mobile device corresponds to the building location.

In yet another arrangement, the mobility manager 115 can support a blog community that allows users to discuss topics related to a certain building, business, or advertisement. In such regard, users can subscribe to the blog to keep posted of events occurring at the location, even if they are not physically at the location. For example, a user may receive a promotional advertisement associated with a business the user captures in a street-level image. The user can subscribe to the blog to receive updated promotional information, or group user feedback related to the advertisement. Returning back to FIG. 2, at step 211, the method 200 can end.

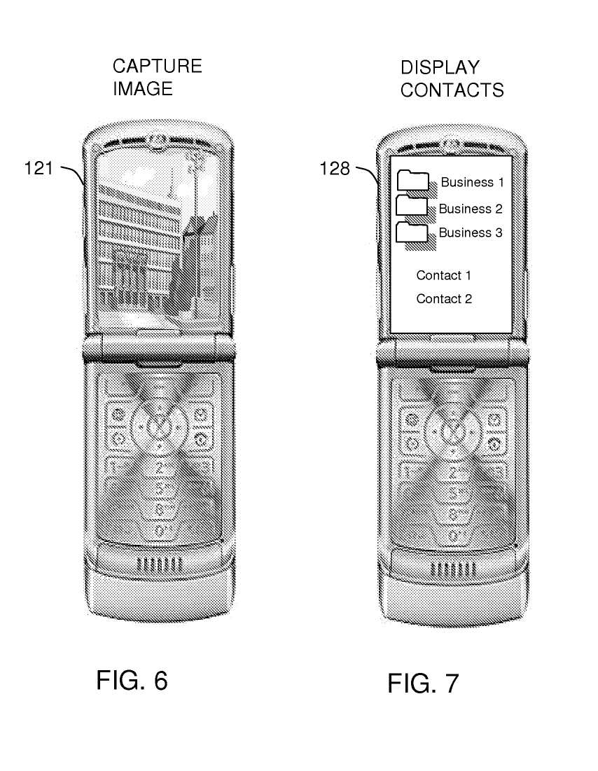

Another embodiment of the invention is directed to ad-hoc group call through listing and social network finding using street-level images for a push-to-talk (PTT) over Cellular device. Briefly, upon taking a picture of a street-level image, a user can be provided with contact information for businesses or people associated with recognized buildings or businesses in the street-level image. For example, referring to FIG. 6, a user can take a picture of a building with the mobile device 110. Upon taking the picture, the mobile device 110 can present a list of contacts associated with the building as shown in FIG. 7. The user can press a push-to-talk (PTT) button to communicate with an individual or business in the list of contacts. Additionally, the manner of calling one or more individuals can be extended to the traditional cellular interconnect call where a user can make a direct call with an individual or may choose to perform a conference call with more than one individual.

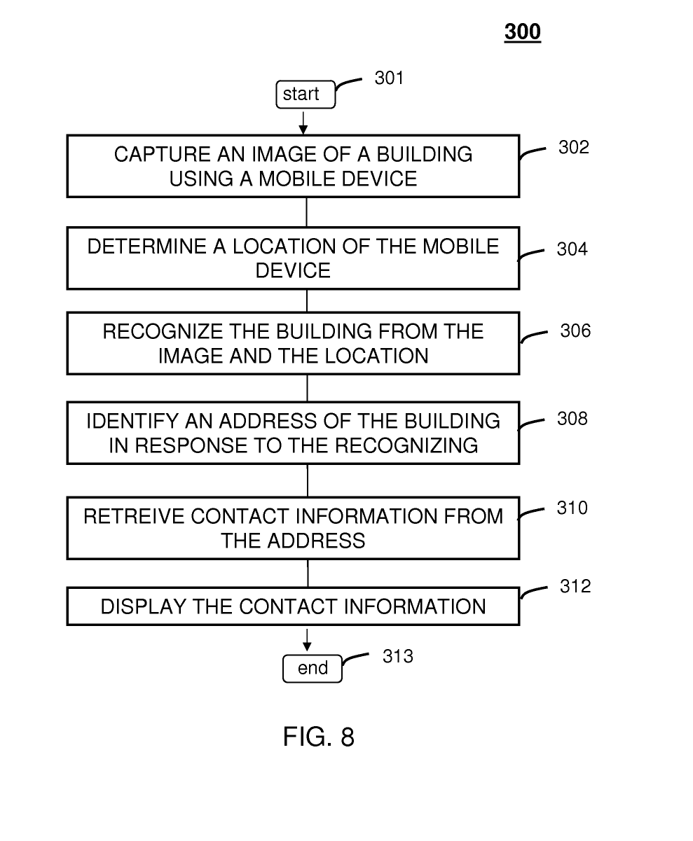

Referring to FIG. 8, a method 300 for automated ad-hoc group call listing and social network finding is provided. The method 300 can be practiced with more or less than the number of steps shown. To describe the method 300, reference will be made to FIGS. 1, 3 and 7-17, although it is understood that the method 300 can be implemented in any other manner using other suitable components. In addition, the method 300 can contain a greater or a fewer number of steps than those shown in FIG. 8.

At step 301, the method 300 can start. At step 302, an image of a building can be captured using a mobile device. Consider that a user captures an image of an office building and wants to generate a list of dispatch or interconnect numbers along with corresponding individual and/or business names. The list can be of the individuals that are currently in the building and the businesses that are represented in the building. Most large office buildings will have numerous businesses that reside within the building so a listing of businesses that are relevant to user would be beneficial. For example, referring to FIG. 7, the user can take a street-level picture 121 of a building. The mobile device 110 can store the street-level picture 121 locally to the device and send the picture to the image server 120 shown in FIG. 1.

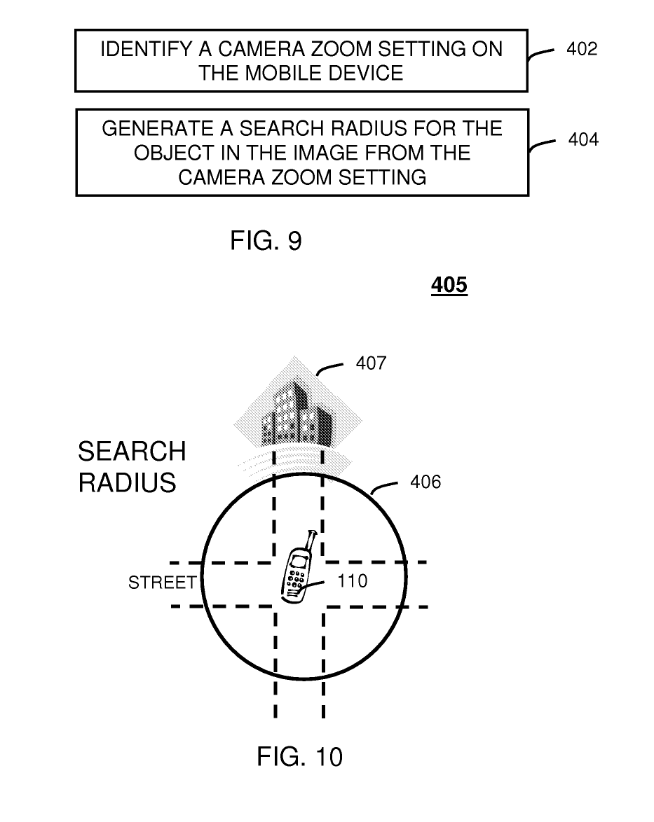

At step 304, a location of the mobile device can be determined. For example, referring back to FIG. 3, the locator 114 can identify a GPS location of the mobile device. The GPS location identifies a physical reference in relation to the image. In addition to providing location information, the processor 118 can identify camera settings for the captured image. For example, referring to FIG. 9, the processor 118 (See FIG. 3) can identify (402) a camera zoom setting on the mobile device, and generate (404) a search radius 406 for the building in the image from the camera zoom setting. Referring to FIG. 10, a street map 405 of the building captured in the image 121 of FIG. 7 is shown. In particular, the search radius 406 is shown in relation to the location of the mobile device 110. That is, the search radius is centered relative to the location of the mobile device. Notably, the camera zoom identifies an area to search for the building in the picture 121. This search radius 406 reduces the number of images the image server 120 is required to search in the image database 125.

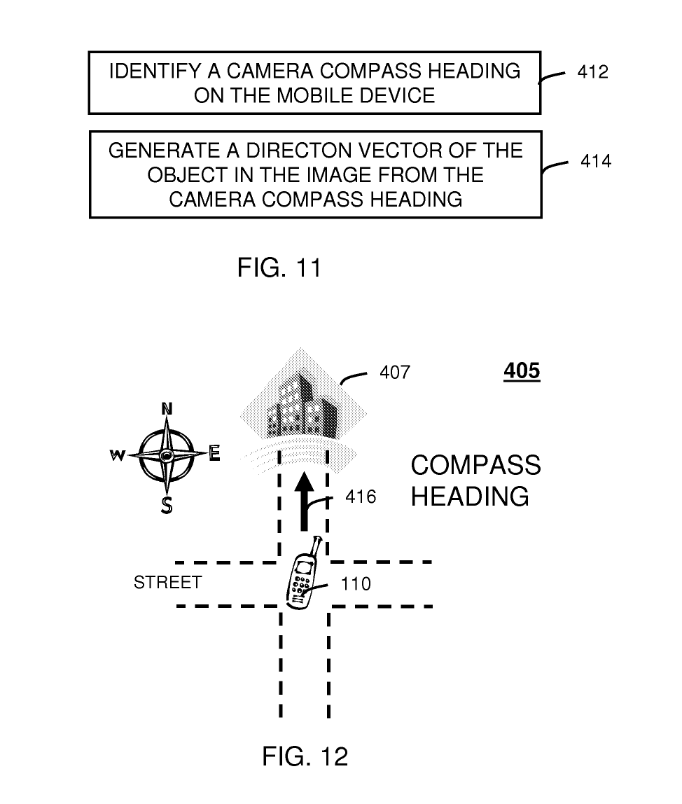

Referring to FIG. 11, the processor 118 (See FIG. 3) can also identify (412) a camera compass heading on the mobile device, and generate (414) a direction vector (416) of the building in the image from the compass heading. The camera compass heading identifies the direction of the building relative to the location of the mobile device. For example, referring to FIG. 12, the camera compass heading can identify the direction vector (416) of the building in the picture relative to the location of the mobile device 110. Notably, the direction vector 416 identifies an area to search for the building in the picture 121. This direction vector 416 reduces the number of images the image server 120 is required to search in the image database 125.

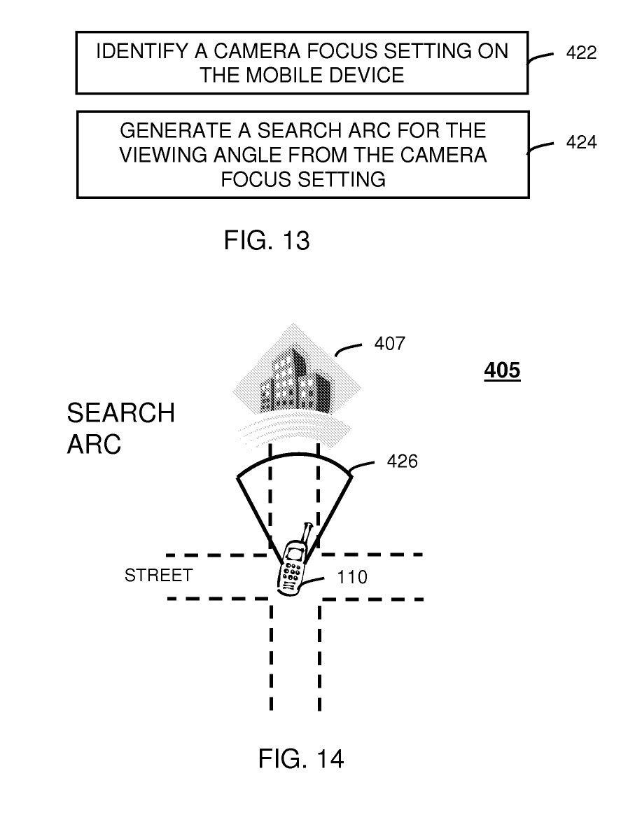

Referring to FIG. 13, the processor 118 (See FIG. 3) can also identify (422) a camera focus setting on the mobile device, and generate (424) a search arc (426) for the building in the image from the camera focus setting. The camera focus setting identifies a region of the building relative to the location of the mobile device, and the direction vector 416 of the mobile device. Notably, the search arc 426 provides a variance to the direction vector 416 for searching. For example, referring to FIG. 14, the camera focus setting can identify a search arc 426 for the building in the picture relative to the location of the mobile device 110. Notably, the search arc 426 identifies a narrowed area to search for the building in the picture 121. The search arc 426 also reduces the number of images the image server 120 is required to search in the image database 125.

In yet another arrangement, a location watermark can be provided in the image to identify a search location and to narrow a field of search. For example, the user can overlay a watermark of a business logo or a text message to further identify the business or building. In one aspect, the user may already know the name of the business, but may want the mobile device to retrieve contacts associated with the business. This can further reduce the search scope for recognizing the building or business, as well as the contacts associated with the building or business. Referring back to FIG. 3, the processor 118 can identify the location watermark in the image, parse the watermark from the image, and provide it to the image server 120. The image server 120 can generate contact information for buildings or businesses in the image 121 from the location of the mobile device 110, the camera settings 117, and the watermark, as shown in FIG. 4.

Returning back to FIG. 8, at step 306, the building can be recognized from the image and the location. Referring back to FIG. 1, the mobile device 110 can upload the image to the image server 120. It should be noted, that an application running on the mobile device 110 can perform the upload automatically. For example, a “recognize it” application can activate the camera and upload the image once the picture is taken. The image server 120 can recognize the building from the image database 125. The image server 120 can also perform image filtering such as edge detection to ensure only an image of the building is recognized. Notably, this allows the user to present an image that only uses the image information alone of the building to generate the search criteria for the dynamic group communications.

At step 308, an address of the building can be identified in response to the recognizing. For example, referring back to FIG. 1, the image server 120 can identify a building from the street-level image. The image server 120 can provide the recognized building to the address server 130. The address server 130 can retrieve an address associated with the building.

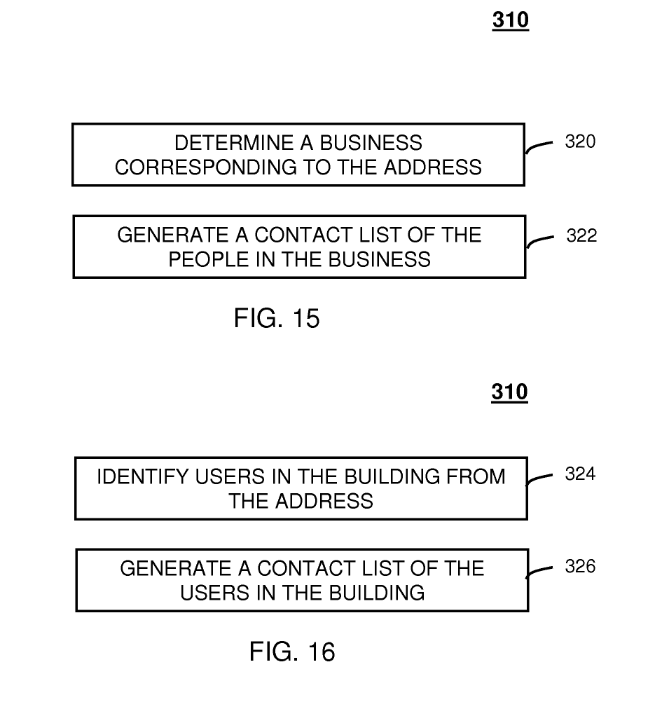

At step 310, contact information can be retrieved from the address. Returning back to FIG. 1, the address server 130 can retrieve contact information associated with the address. For example, referring to FIG. 15, the address server 130 can determine (322) a business corresponding to the address, and generate (324) a list of business contacts for the building or any businesses at the building address. In one arrangement, the address server 130 can be a Push over Cellular (PoC) phone number listing server that provides contact numbers with corresponding descriptive information, such as an individual name or a business. This aspect can be important for emergency situations, where a dispatch operator needs to contact all individuals in a building, for evacuation, in response to an alarm or fire.

In another aspect, a mobility manager can provide location information to the address server 130 for all users in the call group of a PoC system. The address server 130 can provide dynamic contact information to the user based on who is currently in the building. For example, referring to FIG. 16, the address server 120 can identify (324) users in the building from the address, and generate (326) a contact list of the users in the building. In such regard, the address server 130 can identify other users in the call group that are in the building. The address server can monitor a location of the mobile devices in relation to the address determined from the recognized image.

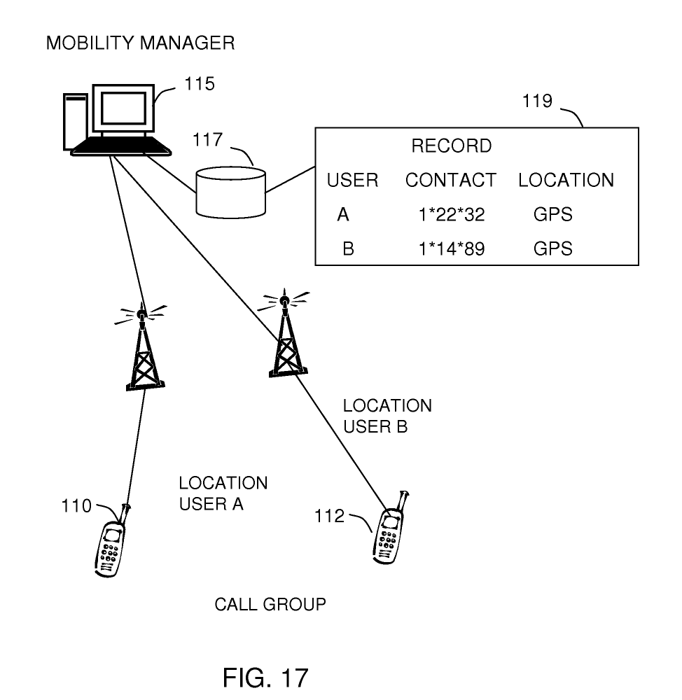

For example, referring to FIG. 17, the wireless communication system 100 of FIG. 1 can also include a mobility manager 115 that can monitor a location of a group of users. The mobility manager can be operatively coupled to a database of records 117. The database 117 can contain records for each user, or mobile device, registered with the mobility manager 115. A record 119 can identify a name of a user, the contact information, and the location of the user. The records can be updated if the location of the user changes. The mobility manager 115 can monitor a location and identify users that enter or leave the location. For example, the location may correspond to an address of a building, and the mobility manager 115 can keep a log of who leaves or enters the building, or are within a proximity of the building.

In one arrangement, the mobility manager 115 can inform users of a location of other users in a call group. For example, the mobility manager 115 can identify a location of a first user A 110 and a second user B 112. If User A 110 and User B 112 are registered to the same call group, the mobility manager 115 can inform each of the mobile devices the whereabouts of the other device. As another example, a user may keep a profile that determines the mobile device's displayed list of users based on the time of day, day of the week, calendar, or location. In particular, upon a user taking a picture of a building, the mobility manager 115 can determine other users in the call group that are currently in the building. As shown in FIG. 3, each mobile device can include a location unit that identifies a GPS location of the mobile device. The mobility manager 115 can monitor the locations of the mobile devices in a call group. More specifically, the image server 120 (See FIG. 1) generates an address that is processed by the address server 130. The address server 130 generates a list of contacts that can be read by the mobility manager 115. The mobility manager 115 can compare the list of contacts to the list of users to determine which users are in the building. For example, the mobility manager 115 can keep track of the location of the mobile devices 111 using global positioning systems (GPS) and determine when one of the devices is in the building. This allows the user taking the picture, to determine who else is in the building, and that may be part of the user's call group.

Returning back to FIG. 8, at step 312, the contact information can be displayed. For example, referring to FIG. 7, a list of contacts 128 can be presented that identifies the contacts associated with, or within, the building. In one aspect, the display can show contacts associated with the building or the business. In such regard, the user is provided with contact information directly from building recognized in the street-level image. In another aspect, the display can also show contacts associated with the users call group. For example, the display can identify other users in the call group that may be in the building at the time the user takes the picture. In such regard, the user can take a picture and automatically locate friends. The contact information may be presented as dispatch or interconnect numbers. For example, as shown in FIG. 7 and FIG. 8, the user captures an image and then presses a push-to-talk (PTT) button on the mobile device 110. The image server 120 receives the request and subsequently provides a list of dispatch and interconnects contact numbers in the user-interface 128. The user can then select the appropriate contact for either contacting or getting more contact information that belongs to the folder. For example, the user can be connected to a business phone or a PTT number associated with the recognized building when pressing the PTT button.

In another aspect, the mobile device 110 or address server 120 may further reduce the contact listing through social network analysis. The mobile device may promote candidates based on a history of contact information in the phone. For example, a mobile device may prioritize a list of individuals or businesses based on recent calls or calling activity to a particular user, business, or contact listed in the mobile device. Moreover, the address server 130 or mobility manager 115 can keep an account of social networking activity. The mobility manager 115 can order the contact list sent from the image server 120 to the mobile device in order of priority. The address server 130 may utilize a much larger scope of activity to determine the social network of influence. As an example, the address server 130 may promote contacts within a building based on the degrees of separation from the user a contact may be. Moreover, the user may create and utilize a profile that determines the device's displayed list of candidates based on the time of day, day of the week, calendar or location.

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiments of the invention is not so limited. Numerous modifications, changes, variations, substitutions and equivalents will occur to those skilled in the art without departing from the spirit and scope of the present embodiments of the invention as defined by the appended claims.

What is claimed is:

1. A method for providing location-specific image information, the method comprising:
receiving a captured image of at least one object from a mobile device;
recognizing the at least one object from both the image and a location of the mobile device; and
retrieving location-specific information associated with the at least one object in the image in response to the recognizing.

2. The method of claim 1, further comprising:
identifying at least one business affiliated with the at least one object; and
retrieving an advertisement associated with the at least one business to allow the advertisement to be overlaid on the image.

3. The method of claim 1, further comprising:
identifying contact information associated with the at least one object from the location-specific information; and
transmitting the contact information for display the contact information on the mobile device.

4. The method of claim 1, wherein the step of recognizing further comprises:
receiving the image and the location of the mobile device at an image server;
recognizing the at least one object from the image and the location of the mobile device; and
sending the location-specific information to the mobile device.

5. The method of claim 4, wherein the receiving further comprises:
receiving a camera zoom setting that identifies a search radius for the at least one object in the image,
wherein the search radius is relative to the location of the mobile device.

6. The method of claim 3, wherein the receiving further comprises:
receiving a camera compass heading that identifies a direction of the image capture,
wherein the direction is relative to the location of the mobile device.

7. A method for advertisement on a mobile device, comprising:
receiving a captured image containing at least one object;
determining a location of the mobile device;
from the image and the location, recognizing the at least one object from a database of images;
retrieving advertisements associated with the at least one object to allow the advertisements to be overlaid onto the image.

8. The method of claim 7, further comprising:
identifying a camera zoom setting on the mobile device;
generating a search radius for the at least one object in the image from the camera zoom setting; and
performing the recognizing based on the search radius.

9. The method of claim 8, further comprising:
identifying a camera compass heading on the mobile device;
generating a direction vector of the at least one object in the image from the camera compass heading; and
performing the recognizing based on the viewing angle.

10. The method of claim 8, further comprising:
adjusting the size of the overlay in proportion to an advertising revenue.

11. A system for providing location-specific image information to a mobile device, the system comprising:
an image server having
a communication unit that receives an image from and a location of a mobile device;
an image database of objects to associate with the image at the location;
a recognition engine that recognizes the at least one object from the location and the image from the image database,
wherein the image server retrieves location-specific information for the at least one object that is recognized and sends the location-specific information to the mobile device.

12. The system of claim 11, wherein the system further comprises:
an address server communicatively coupled to the image server that generates contact information for the location-specific information and that is associated with the at least one object.

13. The system of claim 11, wherein the system further comprises:
an advertisement server communicatively coupled to the image server that retrieves advertisements associated with the location-specific information,
wherein the advertisement server sends the advertisements to the mobile device, and the mobile device overlays the advertisements onto the image.

14. The system of claim 12, further comprising:
a mobility manager communicatively coupled to the address server that monitors a location of users in a communication system and identifies users that are at a location corresponding to the at least one object.

15. The system of claim 13, wherein the at least one object is a building, the image database contains a plurality of street-level images of buildings, and the image server recognizes a building from the image database and generates an address for the building.

16. The system of claim 13, wherein the mobility manager sorts the contact list in order of social activity level.

17. An electronic apparatus comprising:
a camera that captures an image of at least one object;
a locator coupled to the camera that identifies a location of the mobile device;
a processor that recognizes the image; and
a user interface that renders a composite of the original image and one or more sources of image specific information.

18. The electronic apparatus of claim 17, wherein the processor upon recognizing the image, identifies image specific information associated with the image including contacts, advertisements, or messages that are overlaid on the image in the user interface.

19. The electronic apparatus of claim 17, wherein the processor generates audio for the image specific information associated with the image.
